(19) United States
(12) Patent Application Publication
(10) Pub. No.: US 2023/0247063 A1
(43) Pub. Date: Aug. 3, 2023

(54) TECHNIQUES FOR PRIORITIZING RISK AND MITIGATION IN CLOUD BASED COMPUTING ENVIRONMENTS

(71) Applicant: Wiz, Inc., New York, NY (US)

(72) Inventors: Ami LUTTWAK, Binyamina (IL); Yinon COSTICA, Tel Aviv (IL); Roy REZNIK, Tel Aviv (IL); Raaz HERZBERG, Tel Aviv (IL); Alon SCHINDEL, Tel Aviv (IL); Guy ROZENDORN, Tel Aviv (IL); Avihai BERKOVITZ, Tel Aviv (IL)

(73) Assignee: Wiz, Inc., New York, NY (US)

(21) Appl. No.: 18/161,652

(22) Filed: Jan. 30, 2023

Related U.S. Application Data
(60) Provisional application No. 63/267,367, filed on Jan. 31, 2022.

(51) Int. Cl. H04L 9/40

(52) U.S. Cl. CPC H04L 63/205; H04L 63/1441

(57) ABSTRACT

A system and method for prioritizing alerts and mitigation actions against cyber threats in a cloud computing environment. The method includes detecting an alert based on a cloud entity deployed in a cloud computing environment, wherein the alert including an identifier of the cloud entity and a severity indicator, and wherein the cloud computing environment is represented in a security graph; generating a severity index for the received alert based on the identifier of the cloud entity and the severity indicator; and initiating a mitigation action based on the severity index.

### CROSS-REFERENCE TO RELATED APPLICATIONS

This application claims the benefit of U.S. Provisional Patent Application No. 63/267,367 filed on Jan. 31, 2022, the contents of which are hereby incorporated by reference.

### TECHNICAL FIELD

The present disclosure relates generally to cloud computing, and more specifically to alert management and prioritizing risk mitigation in a cloud computing environment.

### BACKGROUND

Cloud computing technologies have allowed to abstract away hardware considerations in a technology stack. For example, computing environments such as Amazon® Web Services (AWS), or Google Cloud Platform (GCP) allow a user to implement a wide variety of software and provide the relevant hardware, with the user only paying for what they need. This shared provisioning has allowed resources to be better utilized, both for the owners of the resources, and for those who wish to execute software applications and services which require those resources.

This technology however does not come without its disadvantages. As the computing environment is now physically outside of an organization, and exposed in terms of access to and from the computing environment, vulnerabilities may be more likely to occur.

While many solutions exist which attempt to block cyberattacks, the reality is that at least some of these attacks will inevitably be successful. An attack may be, for example, unauthorized access to sensitive information, such as information stored in a database. Attacks can be categorized based on severity, for example an attack that merely allows the attacker to see that a file exists on a workload is probably less severe than an attack which allows the attacker to view, or download, that same file.

A cybersecurity vulnerability may be an indication of a potential attack path. For example, a machine that is open to accepting a connection from an external network on any port may be considered vulnerable. Likewise, having out of date software, with known vulnerabilities, may be an indication of a potential attack path. To aid in combating cyberthreats, organizations such as Common Vulnerabilities and Exposures (CVE®) exist. CVE is an example of a system which provides, as the name implies, a database of known vulnerabilities and exposures, in an attempt to categorize and identify them.

This approach makes it easier for organizations to share data about known vulnerabilities and exposures, however it does not provide any indication as to what the impact is on any specific organization. While a good idea in theory, in practice the implementation leads to a large number of alerts, when vulnerabilities are inevitably found.

A human operator typically receives these alerts, which indicate a vulnerability or exposure has been detected, and must decide for each and every alert what action to take. This large number of alerts is difficult to manage, and is nearly impossible for any human to handle in real time, as machines in a cloud environment may be spun up by the thousands, each potentially generating many alerts, some of which may be critical and others which are less so.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for prioritizing alerts and mitigation actions against cyber threats in a cloud computing environment. The method also includes detecting an alert based on a cloud entity deployed in a cloud computing environment, where the alert including an identifier of the cloud entity and a severity indicator, and where the cloud computing environment is represented in a security graph; generating a severity index for the received alert based on the identifier of the cloud entity and the severity indicator. The method also includes initiating a mitigation action based on the severity index.

Certain embodiments disclosed herein also include a non-transitory computer readable medium having stored thereon instructions for causing a processing circuitry to execute a process. The non-transitory computer readable medium also includes detecting an alert based on a cloud entity deployed in a cloud computing environment, where the alert including an identifier of the cloud entity and a severity indicator, and where the cloud computing environment is represented in a security graph; generating a severity index for the received alert based on the identifier of the cloud entity and the severity indicator. The medium also includes initiating a mitigation action based on the severity index.

Certain embodiments disclosed herein also include a system for prioritizing alerts and mitigation actions against cyber threats in a cloud computing environment. The system also includes a processing circuitry. The system also includes a memory, the memory containing instructions that, when executed by the processing circuitry, configure the system to: detect an alert based on a cloud entity deployed in a cloud computing environment, where the alert including an identifier of the cloud entity and a severity indicator, and where the cloud computing environment is represented in a security graph; generate a severity index for the received alert based on the identifier of the cloud entity and the severity indicator. The system also includes initiate a mitigation action based on the severity index.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a security graph portion, implemented in accordance with an embodiment.

FIG. 3 is a user interface for displaying alerts with a severity index, implemented in accordance with an embodiment.

FIG. 4 is a flowchart of a method for prioritizing risk mitigation based on a security graph in a cloud computing environment, implemented in accordance with an embodiment.

FIG. 5 is a schematic diagram of an alert manager according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for prioritizing alerts and corresponding mitigation actions in a cloud security monitoring system. The prioritizing system provides a contextual risk assessment of each alert, and provides an updated risk indicator, based on the context of the cloud environment. This allows to prioritize responses according to real impact on a specific environment, as opposed to a default setting. For example, some threats may be irrelevant in proper context (e.g. Linux based malware on a Windows machine), while others more so (e.g. low level threat on a highly sensitive system).

In this regard, it is recognized that a human is capable of prioritizing a task. However, a human is incapable of repeatedly and reliably applying objective criteria to an alert, a mitigation action, and the like. This is due in part to the sheer volume of alerts in a given computing environment, and in part to a human's inability to apply criteria in an objective manner. It is clear that applying criteria subjectively when dealing with cybersecurity risks is undesirable, as a misapplied criterion can lead to unintended access and exposure of sensitive data.

The system disclosed herein solves at least this problem by applying objective criteria in prioritizing alerts, applying objective criteria based on a determined context, and generates instructions to initiate a mitigating action based on the same objective criteria, thereby providing a reliable solution which is scalable in parallel to scaling of the compute environment. This is something a human brain simply cannot accomplish in a timeframe which is relevant to the operation of a computing environment. For example, a cloud computing environment spins virtual instances up and down constantly, and within short timeframes. By the time a human finishes applying any set of criteria on a virtual instance, the virtual instance may be no longer deployed.

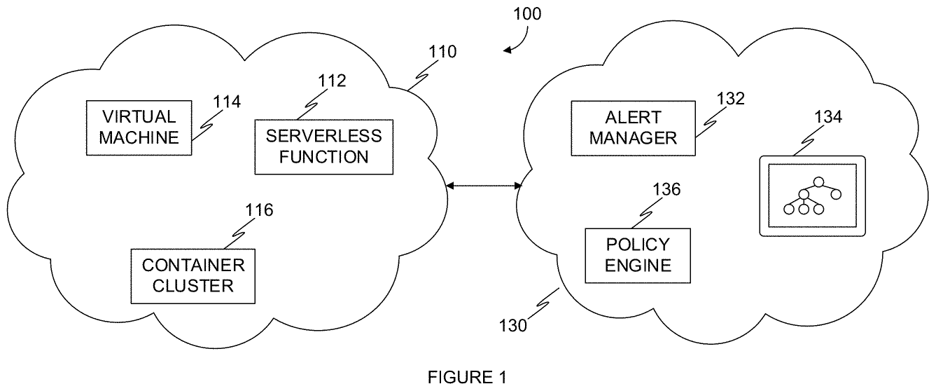

FIG. 1 is an example network diagram 100 utilized to describe the various disclosed embodiments. In an embodiment, two cloud environments are illustrated for simplicity, though it should be readily apparent that different configurations are utilized in other embodiments without departing from the scope of this disclosure.

A production environment 110 is deployed in a first cloud computing infrastructure, according to an embodiment. The first cloud computing infrastructure is, for example, Amazon® Web Services (AWS), Google® Cloud Platform (GCP), Microsoft® Azure, and the like. In an embodiment, the production environment 110 is implemented as a virtual private cloud (VPC) in AWS. In certain embodiments, a production environment 110 is utilized as the main environment from which an organization operates, and is configured to provide a service, such as a software, expose a resource, and the like.

A production environment 110 is differentiated from a staging environment, for example, which is substantially identical to the production environment, but is used for testing purposes in order to test services, workloads, policies, and the like, before implementing them in a production environment, according to an embodiment.

In an embodiment, a production environment 110 includes a plurality of resources. A resource is a workload, such as a serverless function 112, a virtual machine 114, a software container cluster 116, and the like, according to an embodiment. In certain embodiments, the production environment 110 includes a plurality of each of a different resource type. A serverless function 112 is, for example, Amazon® Lambda, a virtual machine 114 is, for example, Oracle® VirtualBox, and a container cluster 116 is implemented using a Kubernetes® platform, according to some embodiments.

In certain embodiments, the production environment 110 further includes a principal (not shown) which operates on a resource. A resource may also be a principal, when operating on another resource, in certain embodiments. A principal is, for example according to an embodiment, a user account, a service account, a role, and the like. In certain embodiments, workloads are configured to be spun up (i.e. provisioned by an orchestrator, not shown), spun down, and the like, as the production environment 110 requires.

For example, a content delivery network (CDN) is a type of production environment which is configured to spin up load balancers and content servers as needed to provide a content, such as when a particular content (e.g., a video) is popular and access is attempted simultaneously from many different client devices. Each workload (in this example, a load balancer, a content server, etc.) is subject to security policies, which are stored, for example, in the production environment 110, in some embodiments.

In certain embodiments, where a workload is determined to be in violation of a policy, an alert is generated, as discussed below. For example, where a workload runs an application which has an outdated version number, an alert is generated, according to some embodiments.

In an embodiment, an alert is generated by a service, for example deployed as the serverless function 112. In some embodiments, the service is configured to monitor a workload in the production environment 110 and generate an alert based on a policy of a plurality of predetermined policies.

In some embodiments, the production environment 110 is communicatively coupled with a security environment 130. In an embodiment, the security environment 130 is implemented as a VPC on top of a cloud computing infrastructure, such as AWS. In an embodiment, the production environment 110 and the security environment 130 are implemented using the same cloud computing infrastructure (e.g., both on GCP).

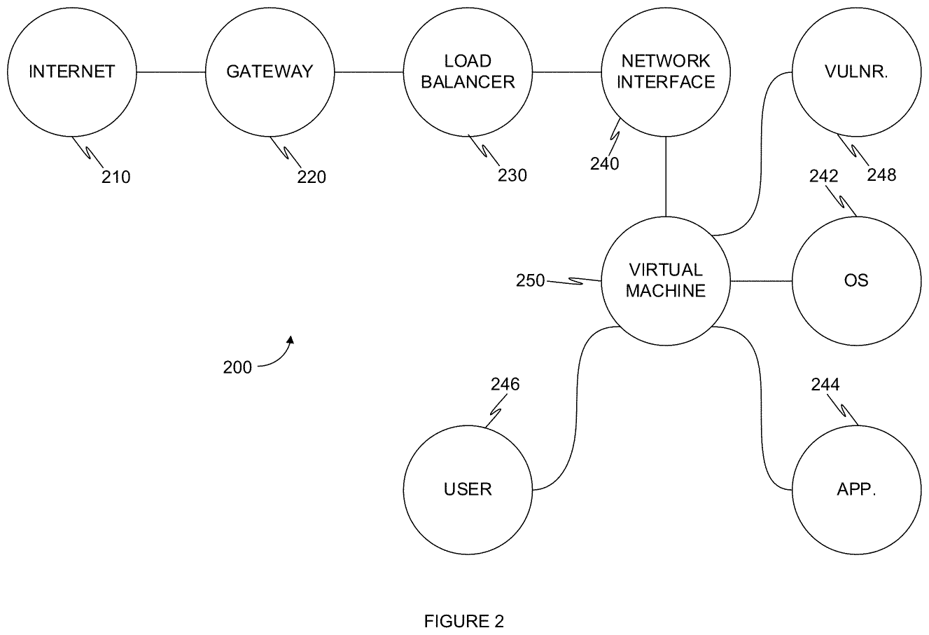

In certain embodiments, the security environment 130 includes an alert manager 132, a graph database 134, and a policy engine 136. In an embodiment, the graph database 134 is configured to store thereon a security graph. In certain embodiments, the security graph includes a representation of a computing environment. The graph database 134 is discussed in more detail with respect to FIG. 2 below, which includes an example of a portion of a security graph. In an embodiment, the security environment 130 further includes a plurality of inspector workloads (not shown). In certain embodiments, each inspector is configured to detect a cybersecurity object in a workload of the production environment 110. For example, in an embodiment, a cybersecurity object is a malware signature, an encryption key, a certificate, a password, a misconfiguration, a vulnerability, an exposure, a combination thereof, and the like.

In an embodiment, the alert manager 132 and the policy engine 136 are each implemented as a workload, such as a node in a software container cluster. In an embodiment, the alert manager 132 is configured to receive alerts. In some embodiments, the received alerts are generated in the production environment 110, the security environment 130, a combination thereof, and the like. According to an embodiment, an alert is generated in response to detecting, for example as a result of an inspection, a cybersecurity threat, an exposure, a vulnerability, a misconfiguration, and the like. In certain embodiments, generating an alert further includes generating a ticket in a ticketing system.

In certain embodiments, each alert includes a severity score, which is a string-based indicator (e.g., severe, moderate, low, etc.), a numerical value (e.g., 1 being lowest severity, 10 being highest), a combination thereof, and the like. In some embodiments, the alert manager 132 is configured to query the security graph stored on the graph database 134 for an output in order to generate a new severity score, the new severity score based for example on the severity score, the generated output, a combination thereof, and the like, as discussed in more detail below.

In some embodiment, a user interface is configured to render alerts based on the new severity score, in order to reprioritize initiation of a mitigation action. This is useful in certain embodiments, as by providing context which is specific to the production environment 110 response time to perceived cyberthreats is decreased, thereby decreasing the likelihood of the production environment 110 being susceptible to a cybersecurity attack. Ideally, each cybersecurity threat is dealt with immediately using any resource required. In practice however, resources are limited, and prioritization must occur in order to best utilize those resources. Therefore, it is desirable in some embodiments, to prioritize alerts so that the underlying cybersecurity issue which causes an alert is dealt with according to urgency and importance.

In an embodiment, a policy engine 136 includes a plurality of policies, which are applied to resources, principals, and the like, in the production environment 110. In some embodiments, a policy includes a conditional statement, such as “if a machine runs an outdated software application then an alert is generated having a medium severity”. It should be understood that the former example is declaratory in nature, and embodiments where a rule is implemented based on a structured language are possible. In an embodiment, the policy engine 136 includes a plurality of queries, each query corresponding to a policy. In some embodiments, the policy engine 136 is configured to execute the queries on the security graph stored in the graph database 134 in order to determine if a resource, a principal, a combination thereof, and the like, violate a policy corresponding to a query.

For example, in an embodiment a vulnerability exists on a database, which for a first organization (i.e., a first production environment) is critical, but for another organization (i.e., a second production environment) the same type of database is used only for redundancy, making the same vulnerability there, less critical. Therefore, it is useful to apply a policy to a detected cybersecurity threat, an alert generated based on the same, and the like, in order to utilize a context of the cybersecurity threat and prioritize initiation of mitigation actions.

FIG. 2 is an example of a security graph 200 portion, implemented in accordance with an embodiment. In an embodiment, a security graph 200 represents a computing environment, such as the production environment 110 of FIG. 1 above, in a graph database, according to a predefined data schema. In some embodiments, a cloud computing environment is represented in a graph database by mapping resources, principals, enrichments, and the like, to nodes in the security graph 200 and generating connections between the generated nodes. For example, in an embodiment, a resource node 220 represents a resource, such as a workload (e.g., a virtual machine, a software container, a serverless function, an application, and the like). In some embodiments, a principal node 246 represents a user account, a service account, a role, and the like. In an embodiment, an enrichment node represents an endpoint, for example having access to a public network (e.g., the Internet), a vulnerability, other attributes of a workload, and the like.

In an embodiment, an enrichment node 210 represents internet access, such that any node which is connected (e.g., by an edge) to the enrichment node 210, represents a resource which is capable of accessing the internet. In an embodiment, a resource node 220 represents a gateway workload, which is implemented, for example, as a node in a software container cluster. In certain embodiments, a second resource node 230 represents a load balancer workload, which is connected by an edge to the resource node 220 representing the gateway, and to a network interface node 240, which represents a network interface.

In an embodiment, the network interface node 240 is connected to a resource node 250 which represents a virtual machine, such as the virtual machine 114 of FIG. 1. In an embodiment, the virtual machine 114 includes, for example, an operating system (OS) represented by OS node 242, an application which is executed on the OS of the virtual machine 141, represented by application node 244, a user account node 246 which represents a user account, the user account having access to the virtual machine 114, and a vulnerability node 248, which represents a vulnerability which was detected as being present on, or pertaining to, the virtual machine 114.

For example, in an embodiment, an inspector is configured to inspect a disk of the virtual machine 114 for a cybersecurity threat, such as a vulnerability. In response to detecting the vulnerability, the inspector is configured to generate a node representing the vulnerability in the security graph 200, and generating a connection between the node representing the vulnerability (i.e., vulnerability node 248) and the resource node 250 which represents the virtual machine, according to an embodiment. A vulnerability is, in an embodiment, an outdated software, a specific open port, a user account with excessive permissions, a combination thereof, and the like.

Generating a node representing a vulnerability allows for a compact representation of the computing environment. Rather than store, for each node, data which describes the same vulnerability, that data is stored as a single node, and each node representing a resource which has the same vulnerability is connected to the vulnerability node. Thus, redundant information is not stored, allowing less storage space utilized, resulting in a compact representation without loss of information.

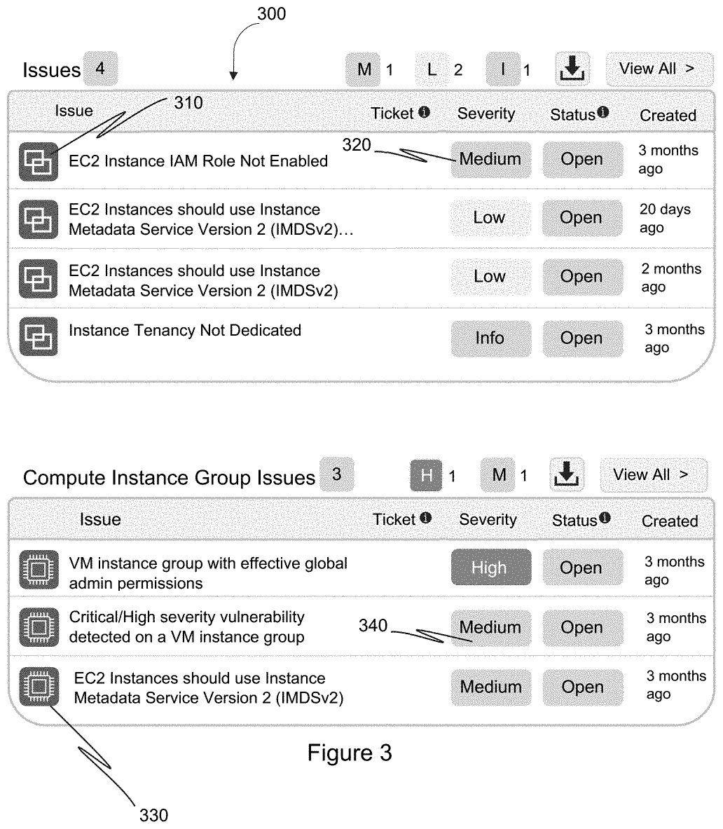

FIG. 3 is an example of a user interface 300 for displaying alerts with a severity index, implemented in accordance with an embodiment. In certain embodiments, the alert manager 132 of FIG. 1 above is configured to generate the user interface 300, generate instructions for rendering the same, and the like.

In an embodiment, the user interface 300 is configured to display a plurality of alerts, such as first alert 310, and corresponding severity, such as first severity 320. For example, the first alert 310 is generated based on a policy (i.e., EC2 Instance IAM Role Not Enabled) which is applied to a workload, such as the virtual machine 114, according to an embodiment. In an embodiment, the first alert 310 has a first severity 320 indicating a medium-level threat.

In some embodiments, a second alert 330 is based on detecting a vulnerability on the virtual machine (e.g., Critical/High severity vulnerability detected on a VM instance group), wherein the vulnerability has a default severity of Critical/High. However, in some embodiments, the alert manager is configured to determine that for this specific alert, the severity should be replaced with a new severity index 340, which corresponds to a medium-level threat.

For example, in an embodiment, generating the new severity index 340 is based on traversing a security graph and determining that the virtual machine does not contain any sensitive data, cannot access other machines in the production environment, cannot be accessed from an external network, and the like mitigating factors. In an embodiment, determining that a resource includes a mitigating factor includes generating a query, for example based on an identifier of the resource, to determine if a node representing the resource is connected to another node which represents a mitigating factor.

In certain embodiments, determining that a resource includes a mitigating factor includes generating a query to determine if a node representing the resource is not connected to a node which represents a non-mitigating factor. For example, a non-mitigating factor is, in an embodiment, a node representing sensitive data, a node representing Internet access, a node representing an vulnerability, a node representing an exposure, a node representing a misconfiguration, a combination thereof and the like.

In the example illustrated in FIG. 2 above, if the virtual machine is not connected via a gateway to the internet, then while the vulnerability does exist, the likelihood of it being exploited is diminished, as in order to exploit the vulnerability, external access must be enabled.

In an embodiment, a control policy includes a plurality of attributes. The control policy corresponds to a vulnerability, such that the attributes of the control policy match indicators of the vulnerability, according to an embodiment. For example, in an embodiment, an indicator requires a vulnerability to be on a machine which is accessible from the internet, run a certain operating system, have a certain software application version installed, and the like. Each such indicator corresponds to an attribute of the control policy, which in turn can be checked (e.g., by comparing values) against attributes of a node representing a resource in a security graph, in accordance with an embodiment.

In certain embodiments, an alert, such as the first alert 310, is generated in response to any of: detecting a malware object on a cloud entity, determining an exposure path to a cloud entity, detecting a lateral movement associated with a cloud entity, detecting a misconfiguration, detecting a policy violation in a corresponding infrastructure as code (iMac) environment, a combination thereof, and the like. A cloud entity is, according to an embodiment, a principal, a resource, an enrichment, and the like. Detecting a malware object includes, in an embodiment, inspecting a disk of a workload for a malware object, for example by detecting a signature of a malware code in the disk.

In an embodiment, a misconfiguration is, for example, a database which is not password protected, a firewall having open ports, an open bucket, and the like. In some embodiments, a code object in an IaC environment is matched to a node on a security graph. A policy is applied to the code object, for example, the same policy which is applied to the node. In an embodiment, the code object is stored as a node on the security graph. In certain embodiments the code object is a code object from which a resource, such as the virtual machine 114, is deployed in a cloud computing environment.

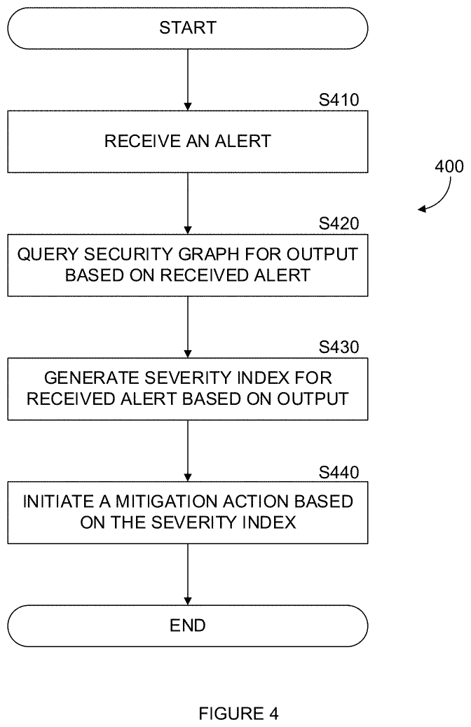

FIG. 4 is an example of a flowchart of a method for prioritizing risk mitigation action initiation, based on a security graph in a cloud computing environment, implemented in accordance with an embodiment. In certain embodiments, prioritizing alerts allows to prioritize mitigation actions which are initiated in response to alert generation. This is advantageous, in some embodiments, in order to prioritize resource allocation utilized by such mitigation actions.

At S410, an alert is received. In an embodiment, the alert further includes a severity score. In certain embodiments, the severity score is determined from an external database, for example from the CVE® (Common Vulnerabilities and Exposures) database. In an embodiment, the alert is generated based on a policy, and corresponds to a resource, a principal, and the like.

In certain embodiments, a plurality of alerts are received. In an embodiment, an alert is generated in response to detecting a cybersecurity threat by an inspector. For example, according to an embodiment, an inspector is configured to detect a cybersecurity threat, such as a vulnerability, a misconfiguration, an exposure, and the like, and generate an alert based on the detected cybersecurity threat. In some embodiments, the alert further includes an identifier of a resource on which the cybersecurity threat is detected.

At S420, a security graph is queried. In an embodiment, a query is generated for the security graph based on the received alert, for example based on an identifier of a resource which is detected in the received alert. In some embodiments, the received alert is parsed to detect data values which are utilized in generating a query which is executed on the security graph.

For example, in an embodiment, the received alert includes data, such as an identifier of a resource (e.g., an identifier of a virtual instance, a workload, and the like) which is utilized by an alert manager which is configured to generate a query for the security graph. In an embodiment, execution of the query generates an output that includes, for example, an identifier of an additional node which is connected to the node that matches the data (i.e., the node that represents the resource), attributes of the matched node, and the like.

In certain embodiments, the alert is based on a cloud entity. A cloud entity is, for example, a workload type (e.g., a VM, a software container, a serverless function, etc.), an application type (e.g., a gateway, a load balancer, etc.), a principal (e.g., a user account, a service account, etc.), an enrichment, a vulnerability, and the like.

At S430, a severity index is generated. In an embodiment, the severity index is generated for the received alert. In certain embodiments, the severity index is generated by the alert manager, which is configured to generate a severity index based on the severity score, and an output of a security graph query.

For example, in an embodiment, the alert is based on a virtual machine having an out of date application version, for which the severity score is “low”. In certain embodiments, an output is generated based on querying the security graph with an identifier of the virtual machine. For example, an output of the security graph query indicates that the virtual machine hosts a database which has a high priority (e.g., sensitive data). In some embodiments, the output includes an identifier of an application which is represented by a node connected to a node representing the virtual machine.

In some embodiments, the alert manager is configured to generate a severity index having a value of “Critical”, based on the high priority database. In this example, the security graph is queried based on the identifier of the virtual machine. A corresponding node is found, which is connected to a node representing the critical database. Data of the corresponding node, such as an identifier, or other attribute(s), are returned as part of the output generated by the security graph. Node attributes, are for example, data field values, such as unique identifier, IP address, workload type, and the like.

In certain embodiments, the alert manager is configured to generate a severity index based on the received data of the corresponding node and the severity score of the alert. In an embodiment the alert manager is configured to generate the severity index further based on a policy applied to the received data from the security graph, and the received alert.

At S440, a mitigation action is initiated. In an embodiment, a plurality of mitigation actions are initiated, each mitigation action at a different time, such that a mitigation action which corresponds to an alert having a higher severity index is initiated prior to a mitigation action which corresponds to an alert having a lower severity index. In certain embodiments, a mitigation action includes revoking access to a network resource, revoking access to an endpoint, initiating installation of a software on a resource, generating an updated alert based on the severity index, generating another alert based on the received alert and the severity index, generating a ticket in a ticketing system, a combination thereof, and the like.

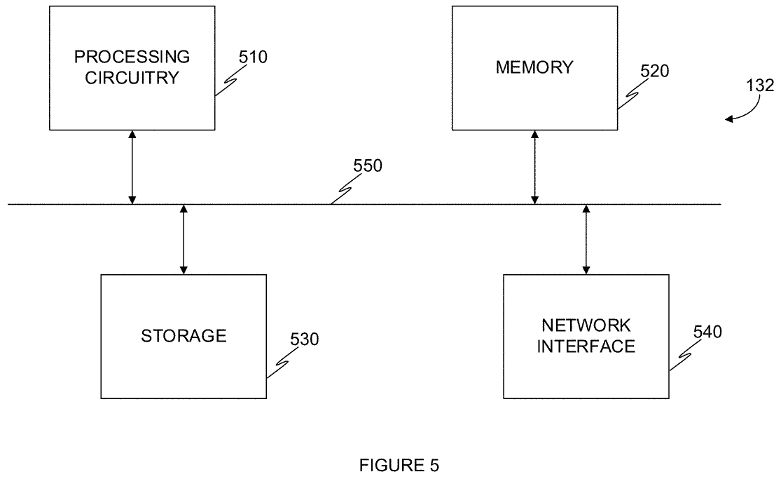

FIG. 5 is an example schematic diagram of an alert manager 132 according to an embodiment. The alert manager 132 includes a processing circuitry 510 coupled to a memory 520, a storage 530, and a network interface 540. In an embodiment, the components of the alert manager 132 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, or any other medium which can be used to store the desired information.

The network interface 540 allows the alert manager 132 to communicate with, for example, a security graph, a cloud environment, a policy engine, and the like.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for prioritizing alerts and mitigation actions against cyber threats in a cloud computing environment, comprising:
detecting an alert based on a cloud entity deployed in a cloud computing environment, wherein the alert including an identifier of the cloud entity and a severity indicator, and wherein the cloud computing environment is represented in a security graph;
generating a severity index for the received alert based on the identifier of the cloud entity and the severity indicator; and
initiating a mitigation action based on the severity index.

2. The method of claim 1, further comprising:
generating the mitigation action based on the received alert.

3. The method of claim 1, further comprising:
generating the severity index based on a policy of the cloud computing environment.

4. The method of claim 3, wherein the policy includes a plurality of attributes, each attribute corresponding to an attribute of a node representing the cloud entity in the security graph.

5. The method of claim 4, wherein at least a portion of the plurality of attributes each corresponds to a vulnerability indicator.

6. The method of claim 1, further comprising:
generating the alert in response to any one of: detecting a malware object on the cloud entity, determining an exposure path to the cloud entity, detecting a lateral movement associated with the cloud entity, detecting a misconfiguration, and detecting a policy violation in a corresponding infrastructure as code environment.

7. The method of claim 1, further comprising:
querying the security graph based on the identifier of the cloud entity to generate an identifier of another node, wherein the another node is connected by an edge to a node representing the cloud entity; and
generating the severity index based on the identifier of the another node.

8. The method of claim 1, wherein the severity indicator is received from a common vulnerabilities and exposures database.

9. The method of claim 1, further comprising:
inspecting the cloud entity to detect a cybersecurity threat; and
generating the severity indicator based on the detected cybersecurity threat.

10. A non-transitory computer readable medium having stored thereon instructions for causing a processing circuitry to execute a process, the process comprising:
detecting an alert based on a cloud entity deployed in a cloud computing environment, wherein the alert including an identifier of the cloud entity and a severity indicator, and wherein the cloud computing environment is represented in a security graph;
generating a severity index for the received alert based on the identifier of the cloud entity and the severity indicator; and
initiating a mitigation action based on the severity index.

11. A system for prioritizing alerts and mitigation actions against cyber threats in a cloud computing environment, comprising:
a processing circuitry; and
a memory, the memory containing instructions that, when executed by the processing circuitry, configure the system to:
detect an alert based on a cloud entity deployed in a cloud computing environment, wherein the alert including an identifier of the cloud entity and a severity indicator, and wherein the cloud computing environment is represented in a security graph;
generate a severity index for the received alert based on the identifier of the cloud entity and the severity indicator; and
initiate a mitigation action based on the severity index.

12. The system of claim 11, wherein the memory contains further instructions which, when executed by the processing circuitry, further configures the system to:
generate the mitigation action based on the received alert.

13. The system of claim 11, wherein the memory contains further instructions which, when executed by the processing circuitry, further configures the system to:
generate the severity index based on a policy of the cloud computing environment.

14. The system of claim 13, wherein the policy includes a plurality of attributes, each attribute corresponding to an attribute of a node representing the cloud entity in the security graph.

15. The system of claim 14, wherein at least a portion of the plurality of attributes each corresponds to a vulnerability indicator.

16. The system of claim 11, wherein the memory contains further instructions which, when executed by the processing circuitry, further configures the system to:
generate the alert in response to any one of: detecting a malware object on the cloud entity, determining an exposure path to the cloud entity, detecting a lateral movement associated with the cloud entity, detecting a misconfiguration, and detecting a policy violation in a corresponding infrastructure as code environment.

17. The system of claim 11, wherein the memory contains further instructions which, when executed by the processing circuitry, further configures the system to:
query the security graph based on the identifier of the cloud entity to generate an identifier of another node, wherein the another node is connected by an edge to a node representing the cloud entity; and
generate the severity index based on the identifier of the another node.

18. The system of claim 11, wherein the severity indicator is received from a common vulnerabilities and exposures database.

19. The system of claim 11, wherein the memory contains further instructions which, when executed by the processing circuitry, further configures the system to:
inspect the cloud entity to detect a cybersecurity threat; and
generate the severity indicator based on the detected cybersecurity threat.
